(19) United States
(12) Patent Application Publication
(10) Pub. No.: US 2006/0261528 A1
(43) Pub. Date: Nov. 23, 2006

(54) Shock absorber for a storage system

(75) Inventors: Chor Shan Cheng, Singapore (SG); Tak Koon Ooi, Singapore (SG); Yiren Hong, Singapore (SG); Terang Kong Beng Thia, Singapore (SG)

Correspondence Address: SEAGATE TECHNOLOGY LLC C/O WESTMAN;CHAMPLIN & KELLY, P.A., SUITE 1400, 900 SECOND AVENUE SOUTH, MINNEAPOLIS, MN, 55402-3319, US

(73) Assignee: Seagate Technology LLC, Scotts Valley, CA (US)

(21) Appl. No.: 11/135,190

(22) Filed: May 23, 2005

(51) Int. Cl. F16M 1/00

(52) U.S. Cl. 267/136; 267/140.11

(57) ABSTRACT

A shock mount is configured sized to receive a disc drive storage system therein and is configured to surround the disc drive storage system. The shock mount has a plurality of sides and is shaped to fit in a housing. A plurality of shock absorbing protrusions extend from the shock mount. The protrusions are of a shock absorbing material and are configured to hold the data storage device at a spaced apart position from the housing and provide shock absorption therebetween.

### FIELD OF THE INVENTION

This invention relates generally to increasing the shock robustness of storage systems, and in particular embodiments to an apparatus for increasing the shock robustness of a storage system by encapsulating the system in a shock absorbing material.

### DESCRIPTION OF RELATED ART

Personal computers are well known, as are portable personal computers, and other portable electronic devices, such as digital music and video players and recorders, PDAs, and the like. Many portable devices include a hard drive disc drive for storing large amounts of data.

Electronic equipment such as laptops, mini disc players, mp3 players and the like are small and portable. Portable equipment is partially susceptible to mishandling and accidental dropping. Disc drives can suffer from shock damages if they are exposed to a sufficient shock or vibration.

Further, external vibrations and shock may be caused by packaging, transporting, and handling the disc drive. To reduce the possibility of damage, disc drives have been designed to meet certain desired shock specifications. For example, some disc drives use shock absorbers to reduce the damaging effects of shock or vibration to the device. In a portable device, the hard disc drive is frequently the component most sensitive to shock and vibration. In use, the disc in the hard disc drive rotates at a high speed and a read/write head rides very closely above the disc. The head/disc arrangement is very sensitive to both vibration and shock and is easily damaged by either.

A typical disc drive has one or more circular discs, coated on both sides with a thin layer of magnetizable material. These discs can be mounted on a spindle that rotates them at a constant, high speed. For each surface (the top and the bottom of each disc), the drive has a read/write head. These heads are mounted on an actuator assembly that moves them in toward the spindle or out toward the edge of the disc.

Typically, disc drives are designed to keep the heads flying in very close proximity to the surface of the discs. The air flow created between the heads and surface keeps the heads from touching the surface. If the head hits the surface sufficiently hard, for example in a portable device during vigorous activity, the head can damage the disc surface (and possibly the head). In particular, if the head hits the surface and damages a portion of the magnetizable coating, data stored on that portion of the disc may be lost. External vibrations and shock can damage the disc drive by causing the head to impact the disc.

Shock absorbers have used shock mounts to attach a bracket to the disc drive and isolate the disc drive from vibration and shock. The shock mount design protects the disc drive and its components from shock. In another shock mount design, a shock absorbent jacket is used to protect the disc drive from vibration and shock. The shock absorbent jacket is made of a shock absorbing material that encloses the disc drive.

Some prior art devices are flat and dependent purely upon the elastomer material properties to attenuate the shock magnitude. Typically, the thickness of the shock absorbing material is related to the material's shock absorbing capability. The thickness is limited by the location of the disc drive in a host device and physical space constraints. Thus, there is a need to reduce the overall size and the susceptibility to damage from shocks. In the case of small portable applications where internal space available is at a premium, the shock mount should meet certain specifications while occupying minimal space.

The present invention addresses these and other problems, and offers other advantages over the prior art by providing a shock mount for a disc drive to minimize adverse effects of external disturbances.

### SUMMARY OF THE INVENTION

A shock mount assembly for a mounted data storage system is configured to receive the storage system therein. A shock mount is configured to at least partially surround the storage system and to fit in a housing. A plurality of shock absorbing protrusions extend from the shock mount. The protrusions are of a shock absorbing material and configured to hold the storage system at a spaced apart position from the housing and provide shock absorption therebetween.

### BRIEF DESCRIPTION OF THE DRAWINGS

FIG. 1A is a top perspective view of one preferred embodiment of the present invention showing a typical drive system in which a shock mount encapsulates the disc drive and sits in a housing.

FIG. 1B is a top perspective view of the housing used with the disc drive system shown in FIG. 1A.

FIG. 2 is a top perspective view of the drive system shown in FIG. 1 without the housing.

FIG. 3 is a top perspective view of the drive system shown in FIG. 1A with drive inside the shock mount assembly.

FIG. 4 is a side perspective view of the shock mount assembly of FIG. 1A.

FIG. 5 is a side perspective view of the shock mount assembly of FIG. 1A showing a detailed view of shock absorbing protrusions.

FIG. 6A is a top view of the shock mount assembly.

FIG. 6B is a side view of the system shown in FIG. 6A.

FIG. 6C is a front view of the system shown in FIG. 6A.

FIG. 6D is a side perspective view of the system shown in FIG. 6A.

FIG. 7A is a bottom view of the system shown in FIG. 6A.

FIG. 7B is a top view of the system shown in FIG. 6A showing protrusions.

FIG. 7C is a side view of the system shown in FIG. 6A.

FIG. 7D is a front view of portion (d) in FIG. 7C showing protrusions.

FIG. 8 is a graph showing experimental data on the shock experience of the disc drive assembly of FIGS. 6-7 at various heights in comparison to a drive without the shock mount.

FIG. 9A is a top view of another embodiment of the shock mount.

FIG. 9B is a side view of the system shown in FIG. 9A.

FIG. 9C is a front view of the system shown in FIG. 9A.

FIG. 9D is a side perspective view of the system shown in FIG. 9A.

FIG. 10A is a top view of the shock mount of FIG. 9A.

FIG. 10B is a top view of portion (b) of FIG. 10A.

FIG. 10C is a side view of the system shown in FIG. 9A.

FIG. 10D is a view of portion (d) of FIG. 10C enlarged.

FIG. 11 is a side perspective view of another embodiment of the inventive drive system.

FIG. 12 is a side perspective view of the shock mount assembly of FIG. 11.

FIG. 13 is a side perspective cut away view of the shock mount assembly of FIG. 11 showing a detailed view of the shock absorbing protrusions at the back corner.

### DETAILED DESCRIPTION OF ILLUSTRATIVE EMBODIMENTS

As discussed previously, many small, portable devices require large storage capacities. Examples include personal data assistants (PDAs), digital music players and audio recorders, video recorders and playback devices, etc. In order to meet the demands for a high storage capacity, there has been an ongoing effort to reduce the size of data storage devices. However, as the size of components are reduced, the component strength is also reduced thereby making the data storage device more susceptible to damage from impact, vibrations, or the like. The problem is exacerbated because by their very nature, portable devices are much more likely to experience impacts or vibrations than fixed devices. Examples include a user dropping a digital music player, or attempting to use a portable device while engaged in vigorous activities. Further, the design of any shock absorber can be limited because in some instances, the storage device must fit in certain preassigned packages such as a compact flash (CF), PCMICA configuration, or other formats. Further, the shock absorber itself must be bale to dissipate relatively large shock forces, even when the device is used in relatively normal situations. For example, if a device is dropped from 1.5 meters onto a hard surface, the impact can translate into a shock of about 5,000 G with a duration of 0.1 ms. The direction of this impulse is unpredictable and depends on the angle in which the portable device impacts the hard surface. In order to address the problems of mechanical shocks and vibrations applied to data storage devices, various shock absorbing and mounting techniques have been used such as those described previously.

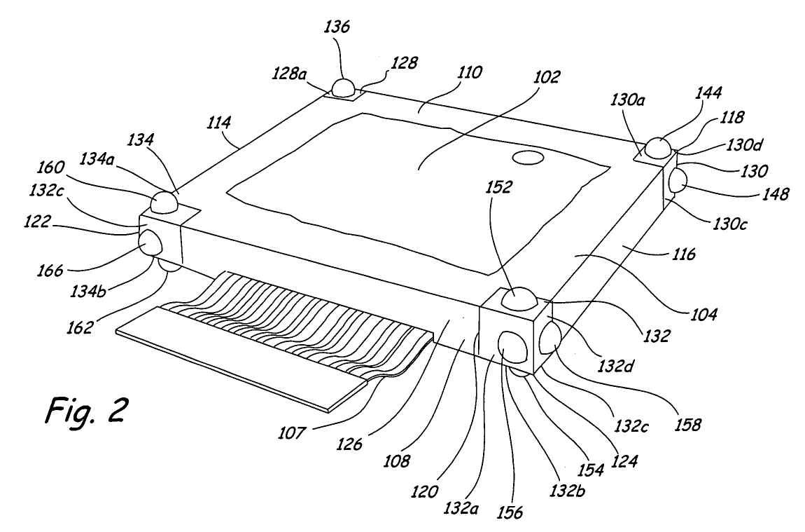

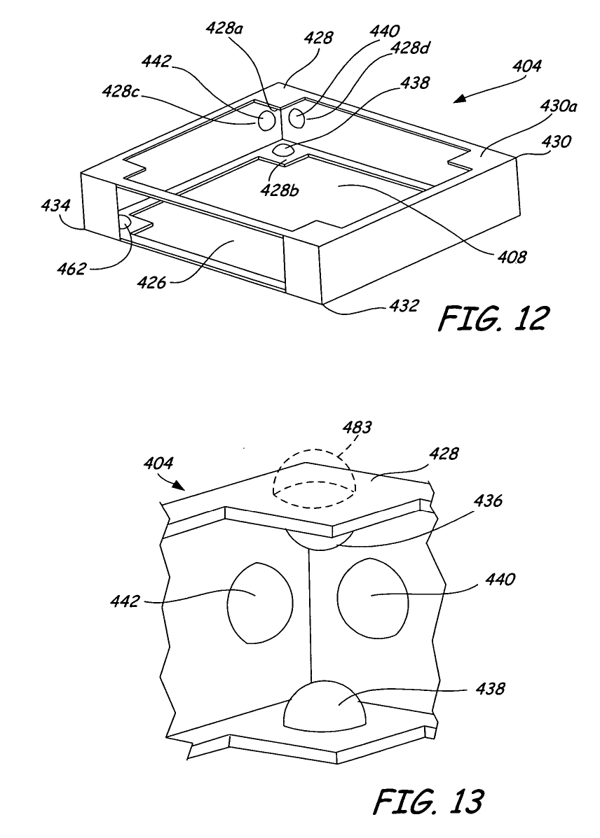

To overcome the limitations in the prior art described above, the present invention includes an apparatus for increasing the robustness of a disc drive. Generally, the present invention includes a storage system that has a shock absorbing material encapsulating a storage device. A shock mount comprises an elastomer that at least partially encompasses the disc drive. Molded shock absorbers in the elastomer hold disc drive firmly in place within the embedded application. In one configuration, a plurality of shock absorbing protrusions extend toward the disc drive and are configured to hold the data storage device at a position spaced apart from the housing or drive and provide shock absorption therebetween. In a preferred embodiment, there is one protrusion extending from the first surface of each corner, one protrusion extending from the second surface of each corner, one protrusion extending from the anterior surface of each corner and one protrusion extending from the posterior surface of each corner. (See generally FIGS. 2 and 12). The design reduces the shock level from all directions. In a preferred embodiment, the protrusions have a cylindrical base and with a spherical top and are designed to improve shock absorption coefficiency by reducing stiffness of the inventive shock mount.

The inventive shock mount design has extended shock absorption features. While some previous designs like the corner shock mount are flat and dependent purely upon the elastomer material properties to attenuate the shock magnitude, the shock mount of the present invention has shock absorbing protrusions which are more efficient at reducing shock in a confined space. Shock absorption in the present invention arises from elastomer material properties of the materials as well as shape of shock absorbers. The protrusions are designed to be highly compressed during shock, but take up minimal space in a normal condition. In a preferred embodiment, the protrusions are strategically placed around the shock mount to provide protection in x-y-z axis. The designed shock mount lowers shock input to the storage device, regardless of impact direction. To obtain similar protection with an elastomeric enclosure without the protrusions requires that the enclosure be much thicker. The present mount is particularly useful in portable devices such as digital audio and video players and recorders, and the portable equipment which uses a storage device.

In the following description of preferred embodiments, reference is made to the accompanying drawings which form a part hereof, and in which is shown by way of illustration a specific embodiment in which the invention may be practiced. It is to be understood that other embodiments may be utilized and structural changes may be made without departing from the scope of the preferred embodiments of the present invention.

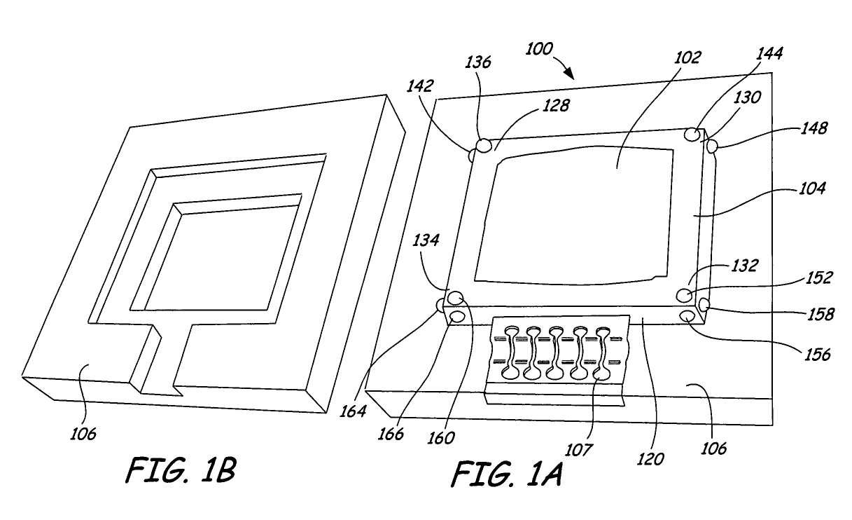

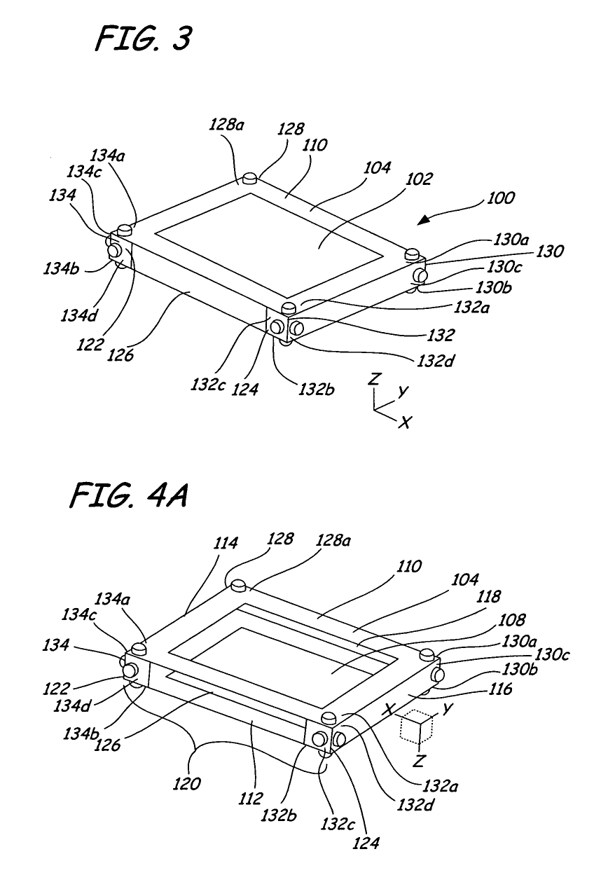

Referring to FIGS. 1-5, one preferred embodiment of the present invention is shown. FIGS. 1-3 illustrate a typical disc drive apparatus 100 mounted in a shock mount of the present invention. Drive 102 is surrounded by shock mount 104 and held in a spaced apart position from housing 106 to provide shock absorption therebetween. Ribbon cable 107 extends from drive 102 onto housing 106. Those skilled in the art will recognize that the exemplary environment illustrated in FIGS. 1-3 is not intended to limit the present invention. Other alternative disc drive and storage system designs may be used without departing from preferred embodiment of the present invention.

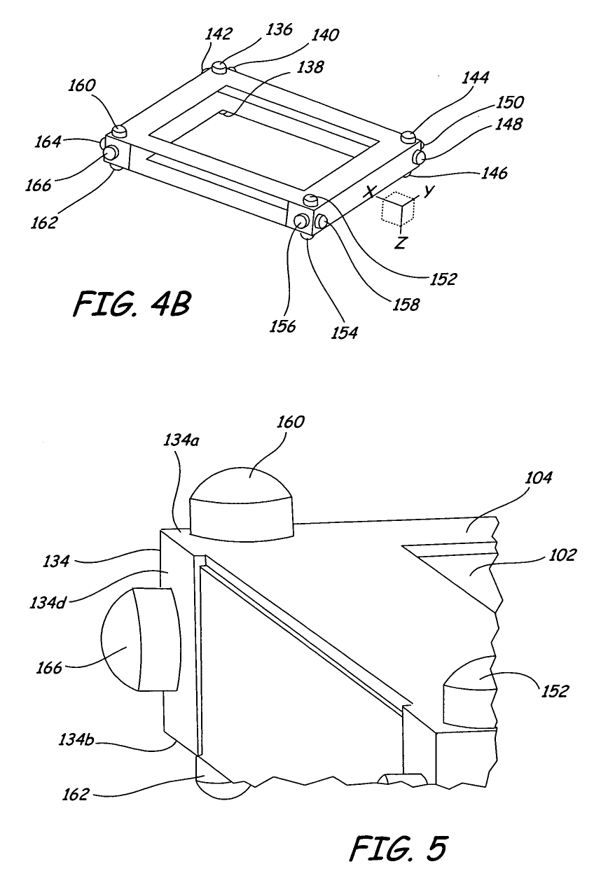

Referring to FIGS. 1-5, shock mount 104 is sized to receive disc drive 102 and comprises a shock absorbing material configured to surround disc drive 102. Mount 104 is illustrated as being configured to fit in a housing 106. Shock mount 104 comprises a molded polymeric structure having a rectangular frame shape molded body with an opening into a central cavity 108 configured to receive and surround the perimeter of disc drive 102. In one embodiment, mount 104 is a single molded piece. Mount 104 also includes first portion 110, second portion 112, opposing side walls 114, 116, a back wall 118, and a front portion 120. Front portion 120 has two perpendicular extensions 122 and 124 from side walls 114 and 116 and a space 126 (see FIG. 4A) for passage of drive 102 into the mount 104 and for access to electrical connectors such as cable 107. Shock mount 104 also has four corner portions 128, 130, 132, and 134. Corner portions 128, 130, 132, and 134 each have a first surface (128a, 130a, 132a, and 134a respectively), a second surface (128b, 130b, 132b, and 134b respectively), a first side surface (128c, 130c, 132c, and 134c respectively) and a second side surface (128d, 130d, 132d, and 134d respectively), where the surfaces face out towards housing 104. Shock mount 104 comprises a plurality of protrusions 136, 138, 140, 142, 144, 146, 148, 150, 152, 154, 156, 158, 160, 162, 164, and 166 where there is a protrusion extending from the first surface of each corner, a protrusion extending from the second surface of each corner, a protrusion extending from the anterior surface of each corner and a protrusion extending from the posterior surface of each corner. In the illustrated configuration, protrusions 136-166 (see FIG. 5) are shaped as a cylinder with a partial or half-sphere on top and are configured to hold disc drive 102 at a spaced apart position from the housing and provide shock absorption therebetween. However, the protrusions can be configured as desired and the invention is not limited to the illustrated embodiment. Protrusions 136-166 are placed at the comers so as to absorb larger shock loads, since most shock loadings that occur during transport and handling of system 100 are focused on the corner portions of the body while the side, end, first and second portions experience less shock loading during shock events such as table drops and corner drops and other handling mishaps. In addition, the design of shock absorber 104 with protrusions 136-166 extending from the corner portions support the drive 102 within housing 106 such that the drive 102 is cradled to distribute shock loads in a manner as to reduce the effect on drive 102 itself.

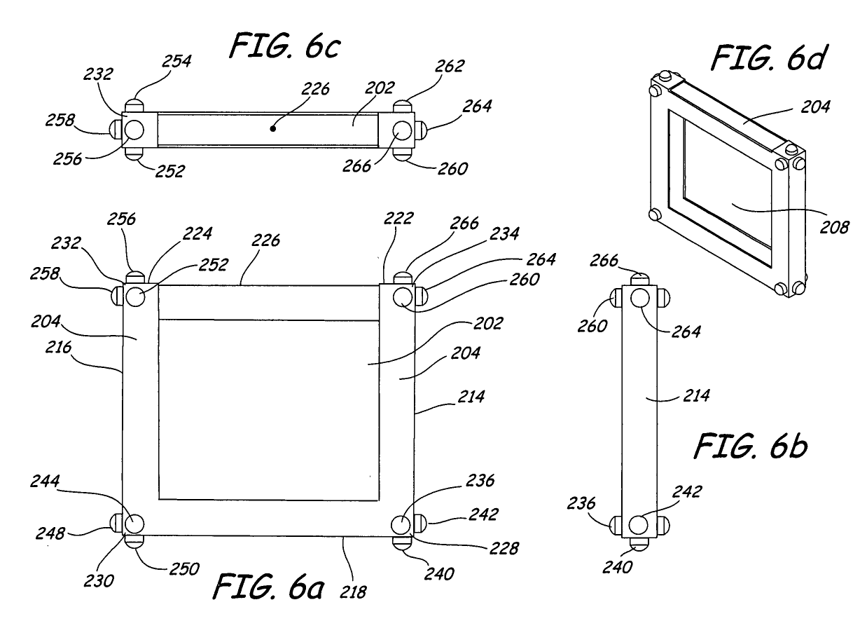

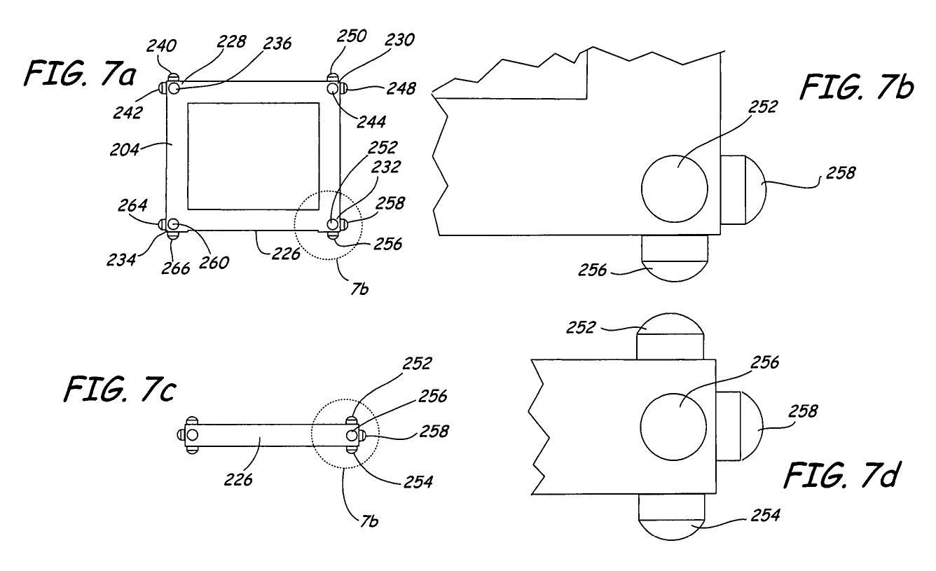

Turning now to one specific example, FIGS. 6 and 7 show a disc drive apparatus 200 for use in a CF (Compact Flash) II type device. This is just one example embodiment and the present invention is not limited to any specific implementation or form of the storage system. For example, the CF type II specification calls for dimensions of about 42.8 mm×36.4 mm×5 mm. Shock mount 204 wraps around type II device 202. Shock mount 204 is sized to receive disc drive 202 and comprises a shock absorbing material configured to surround disc drive 202. Shock mount 204 comprises a one piece molded polymeric structure having a rectangular frame 206 shaped molded body with an opening into central cavity 208 configured to receive and surround the perimeter of disc drive 202. Mount 204 also comprises protrusions 236-266 extending from the outer surfaces of each corner. In one example, the non-protrusion portion of shock mount 204 has a thickness of 0.3 mm, the height of protrusions 236-266 is about 1.8 mm and protrusions 236-266 have a diameter of about 2.65 mm.

The shock mount is preferably molded of an elastomeric material with high damping characteristics such as ethylene propylene dimer (EPDM). In one specific implementation, the shock mount have a Hardness (durometer measurement) Shore A of between about 10 to 50, preferably for the 1.8 mm protrusion, the material is EPDM 30 shore A. Other shock absorbing materials may require different configurations of the protrusions in terms of thickness and surface area. The configuration preferably prevents the material from “bottoming out” and maximize the shock absorbing power.

The shock mount may also be made of any desired material such as natural or synthetic rubber (or its compounds) or plastic. Example rubber candidates are: high damping butyl, impregnated rubber (e.g., Silicone), a thermoplastic elastomer, dispensable e.g., Polyurethane), etc. Example plastics: acrylonitrile-butadiene-styrene copolymer, polypropylene, polyethylene, etc. Other plastic alternatives or other shock absorbing materials can be used.

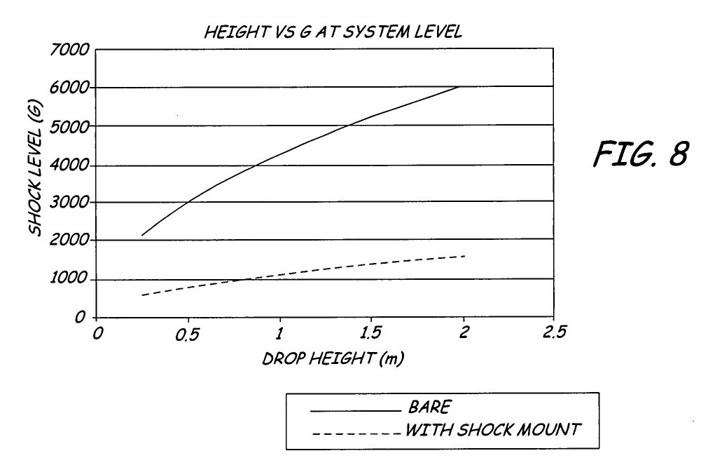

Referring to FIG. 8, a shock mount configured for 1.8 mm height design was tested using a three axes test. The three axes test comprises providing a perpendicular shock input on all six surfaces of the disc drive. The Z axis is defined as the direction perpendicular to the top cover surface of the disc drive. The top cover surface is the surface with the largest surface area. The X axis is defined in the direction of the longest edge of the disc drive and the Y axis is defined in the direction perpendicular to the X axis. The shock input provided by the three axes test is predictable and controlled. In particular, the disc drive was dropped from a specified height and direction related to the magnitude and direction. As illustrated in the graph of FIG. 8, even if a user were to drop a device from 1.5 meters, the shock to this drive is only about 1500 G, almost a third less than the unprotected device which experiences 5000 G.

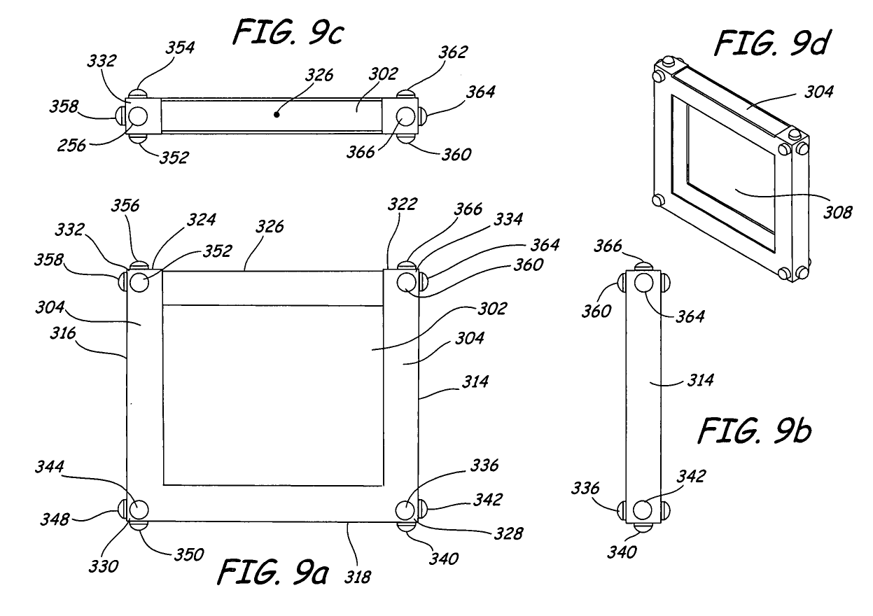

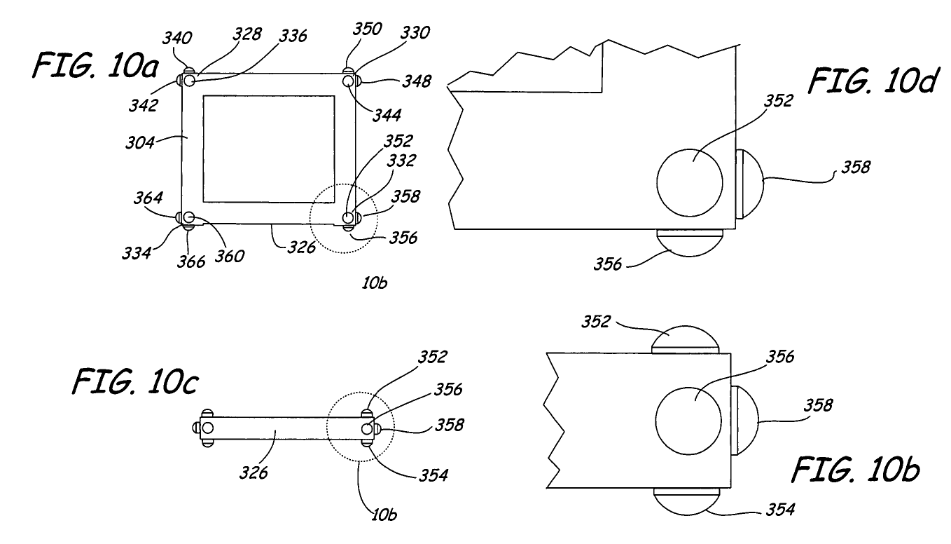

The dimensions and properties of the mount affect the drop height survivability and can be chosen as desired. Referring to FIGS. 9-10, an example configuration for a CF II type device is shown comprising shock mount 304. Depending on considerations related to specific implementations, smaller protrusions can be used to reduce the overall size of shock mount 304. As discussed above, shock mount 304 can comprise a one piece molded polymeric structure having a rectangular frame, similar to the embodiments described above. Mount 304 also includes protrusions 336-366 extending from the outer surfaces of each corner, similar to the embodiments shown in FIGS. 6 and 7. In one specific example, the non-protrusion portion of shock mount 304 has a thickness of 0.3 mm. However, the height of protrusions 336-366 is about 1.0 mm.

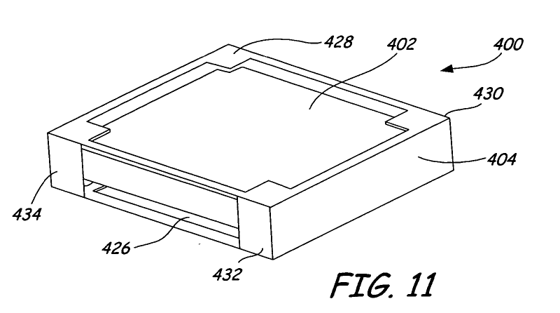

In another embodiment shown in FIGS. 11-13, shock mount 404 is sized to receive disc drive 402 and comprises a one piece molded polymeric structure having a rectangular frame shaped molded body with an opening into central cavity 408 configured to receive and surround the perimeter of disc drive 402. Shock mount 404 comprises has a first portion 410, a second portion 412, a pair of opposite side walls 414, 416, a back wall 418, and a front portion 420. Front portion 420 comprises two perpendicular extensions 422 and 424 from side walls 414 and 416 and a space 426. Shock mount 404 has four corner portions 428, 430, 432, and 434. Corner portions 428, 430, 432, and 434 each have an inner first surface (428a, 430a, 432a, and 434a respectively), an inner second surface (428b, 430b, 432b, and 434b respectively), a first inner side surface (428c, 430c, 432c, and 434c respectively) and a second inner side surface (428d, 430d, 432d, and 434d respectively). In this embodiment, mount 404 includes protrusions 436-466 extending from inner surfaces of each corner. Protrusions 436-466 are configured to hold the disc drive 402 at a spaced apart position from mount 404 and provide shock absorption therebetween. In addition, the design of shock mount 404 with the protrusions extending inward from the corner portions cradles the drive 402 so as to distribute shock loads in such a manner as to reduce the effect on drive 402 itself.

The protrusions described herein can be configured to extend from the shock mount inward and in a direction toward the disc drive, or can be configured to extend in a direction outward from the shock mount toward the housing. Further, in some embodiments, both types of protrusions are used. For example, in FIG. 13, protrusion 483 is shown in phantom. The protrusions may be placed at the four corners of the apparatus, or can be placed at any position as desired, including protrusions which extend inward and protrusions which extend in an outward direction. The location, spacing, dimensions, configurations and materials of the protrusions can be modified and chosen as desired within the scope of the present invention. Further, the protrusions can be formed as integral components with the shock mount or can comprise separate components including components mounted to the disc drive and/or housing.

While a particular embodiment is shown here, this is not intended to be limiting. Although the present invention is described in connection with any CF (compact flash) type II product, the principles of the invention are applicable to other devices as well as other form factors in a disc drive. Furthermore, the application of shock mount can extend to CF type I devices and the invention is not limited to the illustrated dimensions or configurations. Hence, the presently disclosed embodiments are illustrative and not limiting. Also, the particular dimensions and materials described herein are, in general, not limiting but are intended to be illustrative. Hence while the presently disclosed embodiments are for a particular size and mass, in the future hard disc drives may be of other sizes and shapes, and the present shock mounting in general is applicable to changes in the disc drive and the housing. Moreover the disclosed details of the shock mount protrusions and their surface areas are only illustrative and are intended to provide a certain amount of shock and vibration protection; if greater or lesser amounts of shock protection are needed, the size, thickness, and materials of the shock mount protrusions can be changed.

The invention provides a shock absorber apparatus for encapsulating a disc drive, where the shock absorbing apparatus includes a molded polymeric enclosure sized to carry a disc drive therein. The enclosure has protrusions extending from the inner or outer surfaces of the comers of the shock mount where the protrusions distribute shock loads in such a manner as to reduce the effect on the drive itself. In preferred embodiments, the shock mount and protrusions are the form of a single molded component and therefore are the same material. However, in other embodiments, the materials of the body of the shock mount can differ from the protrusions.

The present specification discloses preferred embodiments of an apparatus and process for increasing the shock robustness of disc drives by encapsulating the disc drive in a shock absorbing material. The preferred embodiments of the invention have been presented for the purposes of illustration and description. It is not intended to be exhaustive or to limit the invention to the precise forms disclosed above. Many modifications and variations are possible in light of the above teaching. For example, other form factors and shapes of disc drives may be accommodated by the shock absorber apparatus of the present invention. The location of shock impact may vary and the location and configuration of the protrusions may change as desired. The shock mount can be implemented with any storage device and is not limited to the disc drive storage system set forth herein. Although the shock mount and disc drive illustrations herein are generally square or rectangular shaped, the present invention is not limited to these shapes or configurations.

What is claimed is:

1. A shock mount assembly for a mounted storage system, comprising:
a shock mount configured to receive the storage system therein, the shock mount configured to at least partially surround the storage system and to fit in a housing; and
a plurality of shock absorbing protrusions extending from the shock mount, the protrusions formed of a shock absorbing material and configured to hold the system at a spaced apart position from the housing and provide shock absorption therebetween.

2. The shock mount of claim 1 wherein the protrusions extend outward from the shock mount towards the housing.

3. The shock mount of claim 1 wherein the protrusions extend inward from the shock mount towards the storage system.

4. The shock mount of claim 1 wherein at least one protrusion extends outward from the shock mount towards the housing and at least one protrusion extends inward from the shock mount towards the storage system.

5. The shock mount of claim 1 wherein the shock mount and protrusion comprise a single piece.

6. The shock mount of claim 5 wherein the shock mount and protrusion comprise a molded elastomer.

7. The shock mount of claim 1 wherein the shock mount includes four corners having a first surface, a second surface, an anterior surface and a posterior surface.

8. The shock mount of claim 7 wherein a protrusion extends from each surface of each corner.

9. The shock mount of claim 7 wherein the protrusions extend from the inner surfaces of each corner and are configured to hold the storage system at a spaced apart position from the mount and provide shock absorption therebetween.

10. The shock mount of claim 7 wherein the protrusions extend from the outer surfaces of each corner and are configured to hold the storage system at a spaced apart position from the housing and provide shock absorption therebetween.

11. The shock mount of claim 1 wherein said housing is configured for use as a CF II device.

12. The shock mount of claim 1 wherein the storage system comprises a data storage device.

13. A method for reducing shocks applied to a disc drive storage system, comprising:
placing the storage system in a shock mount;
placing the shock mount in a housing; and
providing a plurality of shock absorbing protrusions extending from the shock mount and configured to hold the system at a spaced apart position relative to the housing and provide shock absorption therebetween.

14. The method of claim 13 wherein the protrusions extend in directions outward from the shock mount towards the housing.

15. The method of claim 13 wherein the protrusions extend in directions inward from the shock mount towards the storage system.

16. The method of claim 13 wherein providing a shock mount and providing a plurality of shock absorbing protrusions comprises molding the shock mount and the plurality of shock absorbing protrusions as a single piece.

17. A disc drive storage system including a shock mount in accordance with the method of claim 13.

18. A shock mount assembly for a mounted disc drive storage system, comprising:
a shock mount means for receiving the storage system therein and at least partially surrounding the disc drive storage system and configured to fit in a housing; and
a plurality of shock absorbing means extending from the shock mount, the shock absorbing means for holding the storage system at a spaced apart position from the housing and providing shock absorption therebetween.

19. The shock mount of claim 18 wherein the plurality of shock absorbing means comprise protrusion means extending outward from the shock mount towards the housing.

20. The shock mount of claim 18 wherein the plurality of shock absorbing means comprise protrusion means extending inward from the shock mount towards the storage system.

21. The shock mount of claim 18 wherein the shock mount means and the plurality of shock absorbing protrusions comprise a single molded piece.
